(19) United States
(12) Patent Application Publication
(10) Pub. No.: US 2014/0110386 A1
(43) Pub. Date: Apr. 24, 2014

(54) COMPRESSIBLE END-FITTING FOR WELDING GUN LINER

(71) Applicant: Robert J. Centner, Frankfort, IL (US)

(72) Inventor: Robert J. Centner, Frankfort, IL (US)

(21) Appl. No.: 13/742,736

(22) Filed: Jan. 16, 2013

Related U.S. Application Data
(60) Provisional application No. 61/717,207, filed on Oct. 23, 2012.

(51) Int. Cl. B23K 9/32

(52) U.S. Cl. CPC B23K 9/32
USPC 219/138

(57) ABSTRACT

A compressible end-fitting for a welding gun liner includes a tubular body. A head is disposed at an end of the tubular body. The head is wider in diameter than the tubular body. A sleeve is disposed around the end portion of the tubular body that includes the head. The sleeve includes a stepped inner surface defining a shoulder. At least one biasing member is disposed between the head and the shoulder. The biasing member(s) urges the head outwardly away from the sleeve. An annular stop on an outer surface of the tubular body is contactable with an edge of the sleeve to limit movement of the head relative to the sleeve. The head is linearly retractable from a resting position into the sleeve by application of an axial force, and the biasing member(s) returns the head to the resting position when the axial force is removed.

### CROSS REFERENCE TO RELATED APPLICATION

This application claims the priority of U.S. Provisional Application No. 61/717,207 filed Oct. 23, 2012.

### TECHNICAL FIELD

This disclosure relates generally to welding systems, and more particularly to a welding system having a welding gun.

### BACKGROUND OF THE INVENTION

Welding is a method of joining, or separating, metal objects. Arc welding is a common type of welding. An arc welding system typically includes a power supply coupled to a welding gun that contains a welding electrode. A ground cable is used to connect the metal object to be welded to the power supply. The electrode in the welding gun completes an electrical circuit between the power supply and the metal object when the electrode is placed against the metal object, allowing electrical current to flow through the electrode and metal object. The electrical current produces an arc between the electrode and the metal object. The heat of the electric arc melts the object in the region surrounding the electric arc. A filler material may be added to the molten metal. For example, a wire may be placed against the molten portion of the object, melting the wire and allowing the molten wire to merge with the molten object. The circuit is broken and the molten mass begins to cool and solidify when the electrode is drawn away from the metal object, forming a weld.

There are several different types of welding systems and techniques. For example, MIG (Metal Inert Gas) welding is one type of arc welding. MIG welding is also referred to as “wire-feed” or GMAW (Gas Metal Arc Welding). In MIG welding, a metal wire is used as the electrode to produce the arc. Other welding systems use a rigid metal rod as the electrode. In MIG welding, for example, the weld area is shielded by an inert gas and the metal wire acts as a filler to add mass to the weld. The inert gas is used to shield the molten metal from outside contaminants and gases that may react with the molten material of the weld.

In MIG welding, the wire and gas are fed to the welding gun from a wire feeder. The wire feeder is, in turn, coupled to a power source and a source of gas, such as a gas cylinder. The welding gun in a MIG system is used to direct the wire and gas to a desired location for welding. Wire is fed from the wire feeder to the welding gun. The gas and wire are directed to a work piece by a neck secured to the gun. In other types of welding, flux, rather than gas, may be conveyed through the welding cable.

MIG welding guns generally consist of two main sections: (i) a flexible cable section which delivers power, shielding gas, electrode wire, and sometimes cooling water to (ii) a rigid neck section which delivers the power, shielding gas, electrode wire, and sometimes cooling water to the welding tip and nozzle. The welding tip and nozzle are secured to the end of the rigid neck section.

Typically, MIG welding guns incorporate a “liner” within the cable and neck sections of the torch. The liner serves as a conduit through which the electrode wire may travel. The main purpose of the liner is to guide the welding electrode and protect the internals of the welding torch from mechanical wear. Liners commonly consist of a long, tubular section with a fitting rigidly affixed to one end. This “end-fitting” acts to locate and retain the liner within the welding gun. It may also act to provide a seal for shielding gas.

The welding gun cable incorporates a feeder “adapter” affixed to one end. This adapter allows the gun to couple with a wire feeder. The adapter also mates with the liner end-fitting.

Wire feeders are available from many manufacturers throughout the world. It is common for wire feeder manufacturers to have their own unique design for the feeder-to-gun interface. No industry standard exists for this connection. Many feeder manufacturers also offer MIG guns which are made specifically to fit their wire feeders.

Aftermarket MIG welding gun manufacturers exist within the welding industry. These companies offer welding guns with differing adapters to mate with the wire feeders from various manufacturers.

A problem for aftermarket welding torch manufacturers is developing a single liner end-fitting that will work with the differing adapters. The end-fitting must physically fit into each different adapter and not interfere with the gun to feeder connection.

A liner is typically inserted into the wire feeder adapter and pushed up the cable section of the gun, into the neck section. The liner is pushed until the end-fitting stops against a seating face on the adapter. A critical feature of a liner end-fitting is its length. Specifically, the length the end-fitting extends from the seating face on the adapter. For ease of discussion, this length may be referred to as the “head length.” A head length that is too long can create an interference with components inside the feeder. This can lead to problems with the wire feeding process. Similarly, a head length that is too short can create unnecessary gaps in the liner end-fitting to adapter connection. This could result in movement of the liner assembly within the adapter and disrupt the shielding gas seal.

A need exists for a liner end-fitting of variable head length. Ideally, the end-fitting should be self-adjusting, requiring no input from an operator.

### SUMMARY OF THE INVENTION

Disclosed is a compressible liner end-fitting having a variable head length. The liner end-fitting may compress when an axial force is applied, and the end-fitting may return to its original length upon removal of the compressive, axial force. The end-fitting may be comprised of multiple components that are able to move linearly and radially about each other, and the multiple components may provide a welding gas seal.

In one embodiment, a compressible end-fitting for a welding gun liner includes a tubular body including a head. The end-fitting also includes a sleeve. A portion of the tubular body is received in the sleeve. The head extends from an end of the sleeve. The disposition of the head relative to the sleeve is self-adjustable upon application of an axial force against the head in order to vary the length of the end-fitting. At least one biasing member may be engaged with and disposed between the head and the sleeve. Each biasing member may be an O-ring or similar.

In another embodiment, a compressible end-fitting for a welding gun liner includes a tubular body. A head is disposed at an end of the tubular body. The head is wider in diameter than the tubular body. A sleeve is disposed around the end portion of the tubular body that includes the head. The sleeve includes a stepped inner surface defining a shoulder. At least one biasing member is disposed between the head and the shoulder. The at least one biasing member urges the head outwardly away from the sleeve. An annular stop on an outer surface of the tubular body is contactable with an edge of the sleeve to limit movement of the head relative to the sleeve. The head is linearly retractable from a resting position into the sleeve by application of an axial force, and the at least one biasing member returns the head to the resting position when the axial force is removed.

Each biasing member may be an elastically compressible member such as a rubber O-ring or a spring. A seal such as an O-ring or similar may be disposed around an outer surface of the sleeve.

In another embodiment, a liner assembly for a welding gun includes a tubular liner and a compressible end-fitting connected to an end of the tubular liner. The compressible end-fitting includes a tubular body. A head is disposed at an end of the tubular body. The head is wider in diameter than the tubular body. A sleeve is disposed around the end portion of the tubular body that includes the head. The sleeve includes a stepped inner surface defining a shoulder. At least one biasing member is disposed between the head and the shoulder. The at least one biasing member urges the head outwardly away from the sleeve. An annular stop on an outer surface of the tubular body is contactable with an edge of the sleeve to limit movement of the head relative to the sleeve. The head is linearly retractable from a resting position into the sleeve by application of an axial force, and the at least one biasing member returns the head to the resting position when the axial force is removed.

Optionally, the tubular liner and the compressible end-fitting have a common axis. The tubular liner and the compressible end-fitting are rotatable with respect to each other about the common axis, and the tubular liner and the compressible end-fitting are moveable linearly with respect to each other along the common axis.

In yet another embodiment, a welding system includes a welding gun and a wire feeder. A power cable connects the welding gun to the wire feeder. A liner assembly extends through the power cable from the wire feeder to the welding gun. The liner assembly includes a tubular liner and a compressible end-fitting connected to an end of the tubular liner. The compressible end-fitting includes a tubular body. A head is disposed at an end of the tubular body. The head is wider in diameter than the tubular body. A sleeve is disposed around the end portion of the tubular body that includes the head. The sleeve includes a stepped inner surface defining a shoulder. At least one biasing member is disposed between the head and the shoulder. The at least one biasing member urges the head outwardly away from the sleeve. An annular stop on an outer surface of the tubular body is contactable with an edge of the sleeve to limit movement of the head relative to the sleeve. The head is linearly retractable from a resting position into the sleeve by application of an axial force, and the at least one biasing member returns the head to the resting position when the axial force is removed.

The power cable may include a wire feeder adapter affixed on an end thereof. The wire feeder adapter is coupled with the wire feeder, and the liner assembly is received in the wire feeder adapter. The wire feeder adapter may include an adapter tip. The adapter tip contacts the head of the liner assembly and may apply the aforementioned axial force on the head.

These and other features and advantages of the assembly will be more fully understood from the following detailed description taken together with the accompanying drawings.

### BRIEF DESCRIPTION OF THE DRAWINGS

In the drawings:

FIG. 1 is an environmental view of a welding system including a welding gun and a wire feeder connected by a power cable;

FIG. 2 is an enlarged view of a portion of FIG. 1 illustrating a wire feeder adapter affixed on an end of the power cable and coupled with the wire feeder;

FIG. 3 is a perspective, partially exploded view of the welding gun and power cable of FIG. 1 including a liner assembly;

FIG. 4 is a perspective view of the liner assembly including a compressible end-fitting;

FIG. 5 is an enlarged perspective view of the compressible end-fitting of FIG. 4;

FIG. 6 is a side view of the liner assembly of FIG. 4 illustrating the compressible end-fitting in an uncompressed resting position;

FIG. 7 is a side view of the liner assembly of FIG. 4 illustrating the compressible end-fitting in a compressed position in which an axial force F is applied to the end-fitting;

FIG. 8 is a sectional view of the liner assembly of FIG. 4 illustrating the compressible end-fitting in the uncompressed resting position;

FIG. 9 is a sectional view of the liner assembly of FIG. 4 illustrating the compressible end-fitting in the compressed position;

FIG. 10 is a sectional view of the liner assembly of FIG. 4 secured in a wire feeder adapter in which the compressible end-fitting is in the uncompressed resting position; and

FIG. 11 is a sectional view of the liner assembly of FIG. 4 secured in an alternative wire feeder adapter in which the compressible end-fitting is in the compressed position.

### DETAILED DESCRIPTION OF THE INVENTION

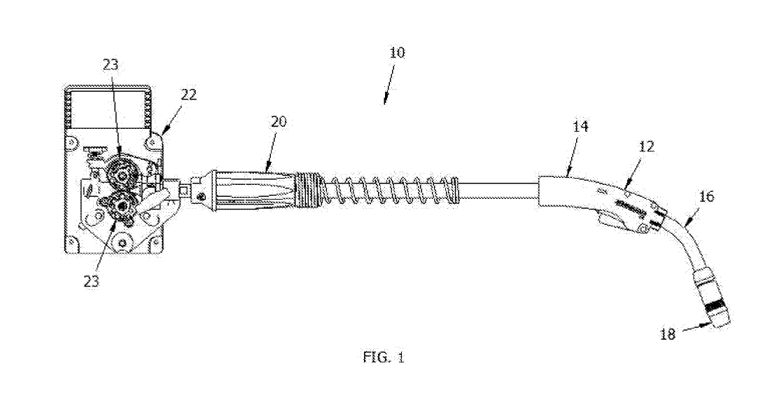

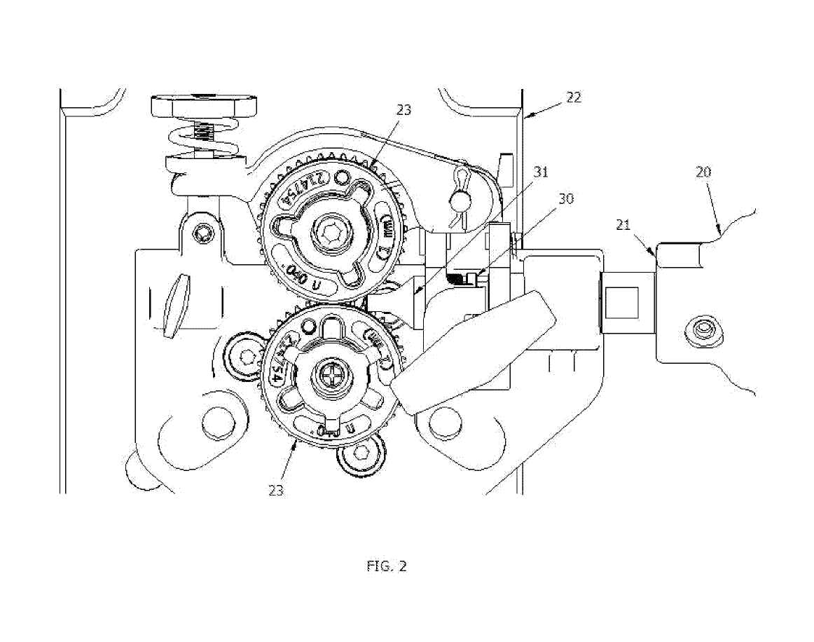

Referring first to FIGS. 1 and 2 of the drawings, numeral 10 generally indicates a welding system including a welding gun 12 such as a gas metal arc welding (GMAW) torch, a metal inert gas (MIG) torch, or similar welding torch. The welding gun 12 broadly includes a main housing 14, a gooseneck 16, and a contact tip assembly 18. A power cable 20 is connected to a rearward end of the main housing 14 to supply one or more of gas, electrical current, and a consumable electrode (e.g., metal welding wire) to the gun 12. An opposite end of the power cable 20 is connected to a wire feeder 22. The gooseneck 16 is operatively connected to a forward end of the main housing 14 and allows for the communication of the consumable electrode, the shielding gas, and the welding current to the contact tip assembly 18 mounted on the gooseneck. The welding gun 12 may be a handheld gun including a trigger or similar switch for use by a human operator, or alternatively the gun may be mounted to a robotic arm for automatic operation.

The wire feeder 22 feeds the welding wire from a wire source such as a wire spool through the welding gun 12, and ultimately through an orifice in the contact tip assembly 18 at the forward end of the welding torch. The welding wire, when energized for welding, carries a high electrical potential. When the welding wire makes contact with target metal workpieces, an electrical circuit is completed and current flows through the welding wire, across the metal workpieces and to ground. The current causes the welding wire and the parent metal of the workpieces in contact with the welding wire to melt, thereby joining the workpieces as the melt solidifies.

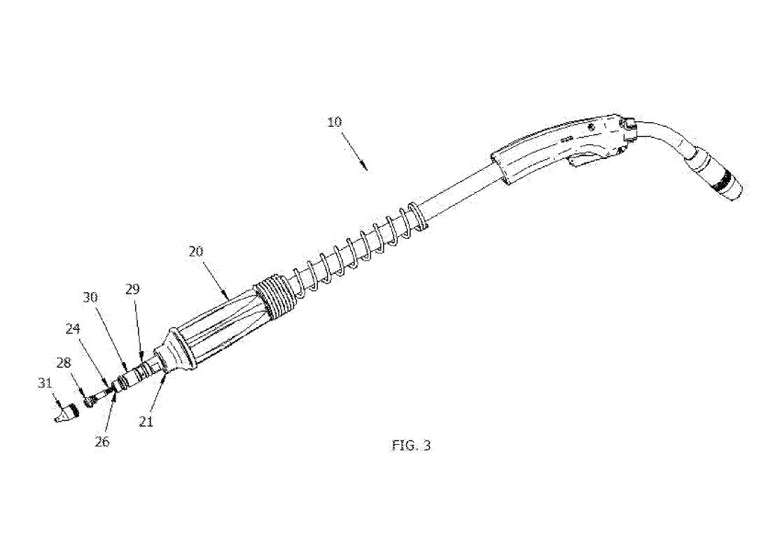

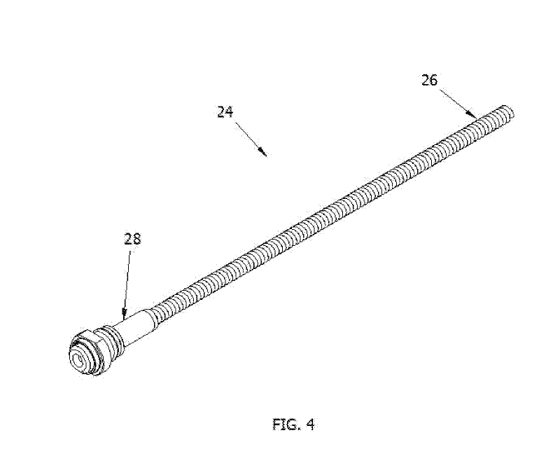

Turning to FIGS. 3 and 4, the welding system 10 includes a liner assembly 24. The liner assembly 24 extends from a wire feeder connecting end 21 of the power cable 20 into the welding gun 12. The liner assembly 24 generally includes a tubular liner 26 and a compressible end-fitting 28. The tubular liner 26 of the liner assembly 24 is an elongated conduit for protectively transporting consumable welding wire from the wire feeder to the welding gun. The compressible end-fitting 28 is connected to an end of the tubular liner 26 and mates with a wire feeder adapter 29 (sometimes referred to as a “power pin”) connected to the wire feed connecting end 21 of the power cable. The wire feeder adapter 29 generally includes a main body 30 including an internal passage in which the liner assembly 24 is received, and a tip 31 which is inserted into the wire feeder and which is disposed directly adjacent (very close to) the drive rolls 23 of the wire feeder in order to receive welding wire from the drive rolls into the wire feeder adapter (see FIG. 2). The distance between the adapter tip 31 and the drive rolls 23 must be kept to a minimum to optimize performance of the wire feeder 22, but the adapter tip also must not contact the drive rolls 23. Therefore, the distance that the adapter tip 31 extends from the main body 30 is critical. The liner assembly 24 ensures this critical distance is achieved for a wide variety of wire feeder adapters as described below.

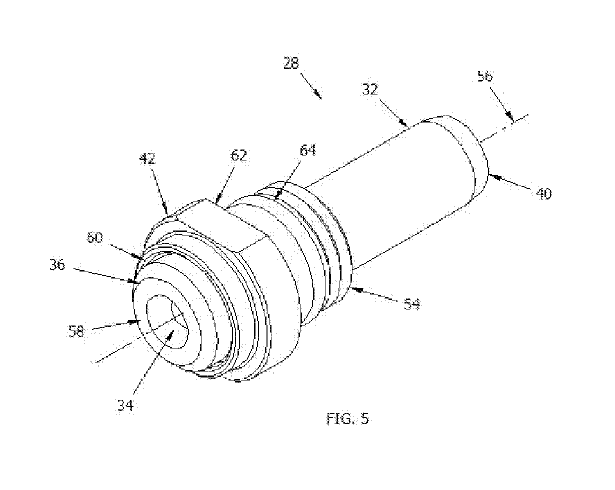

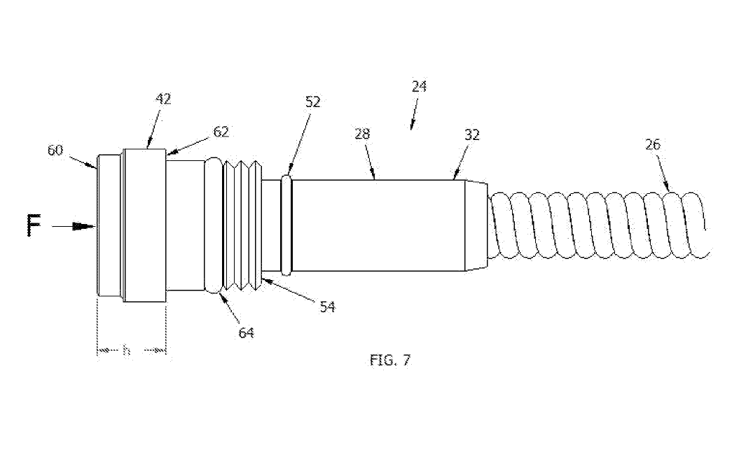

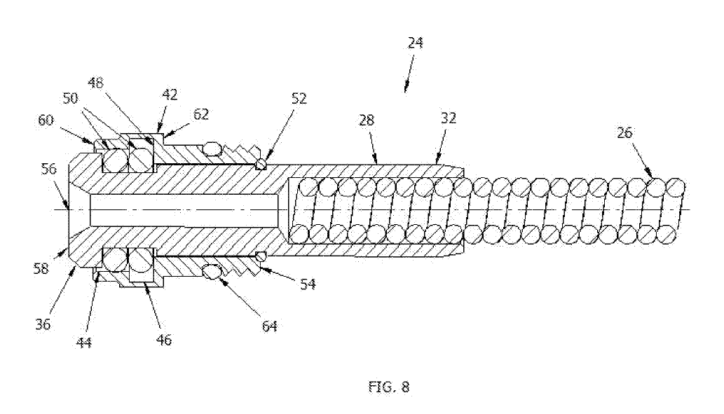

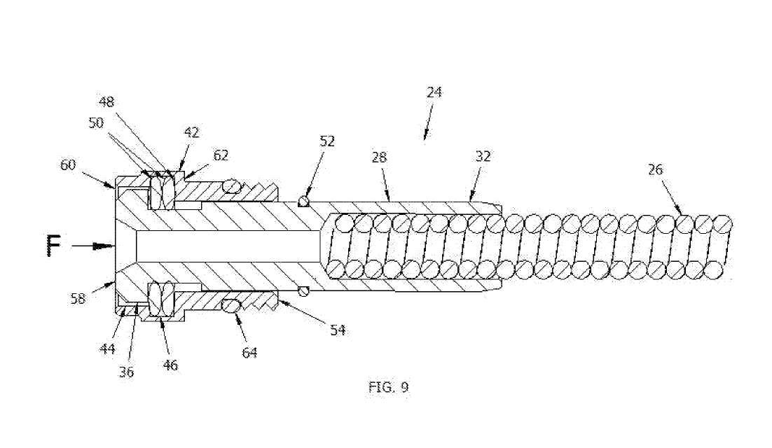

As shown in more detail in FIGS. 5-9, the compressible end-fitting 28 includes an elongated tubular body 32. The tubular body 32 has a throughbore 34 in which the end of tubular liner 26 is received and through which the welding wire travels. A head 36 is disposed at an end 38 the tubular body 32 opposite an end 40 at which the liner 28 is received. The head 36 is wider in diameter than the tubular body 32. A sleeve 42 is disposed around the tubular body 32, and covers an end portion of the tubular body adjacent end 38 that includes the head. In a resting position, the head 36 extends from an opening 44 in the sleeve 42. The tubular body 32 and attached head 36 are slidable along a stepped inner surface 46 of the sleeve 42. The stepped inner surface 46 of the sleeve 42 defines a shoulder 48. At least one biasing member 50 is disposed between the head 36 and the shoulder 48. The biasing member(s) 50 urge the head 36 outwardly through the opening 44 and away from the sleeve 42. Each biasing member 50 may be an elastically compressible member such as a rubber O-ring or compression spring. In the embodiment shown in the drawings, the end-fitting includes two biasing members 50, however it should be understood that the end-fitting may include only one biasing member or greater than two biasing members.

An annular stop 52 is disposed on an outer surface of the tubular body 32. The annular stop 52 is contactable with an edge 54 of the sleeve 42 to limit movement of the tubular body 32 and head 36 in an axial direction relative to the sleeve 42.

A seal 64 may be disposed around an outer surface of the sleeve 42. The seal 64 may be an O-ring or similar. The seal 64 may provide a seal for shielding gas within the wire feeder adapter and the power cable.

The tubular liner 26 and the compressible end-fitting 28 share a common axis 56 that extends longitudinally through the center of the throughbore 34 of the end-fitting and the liner. The tubular liner 26 and end-fitting 28 are moveable linearly with respect to each other along the common axis 56, and are also rotatable with respect to each other about the common axis.

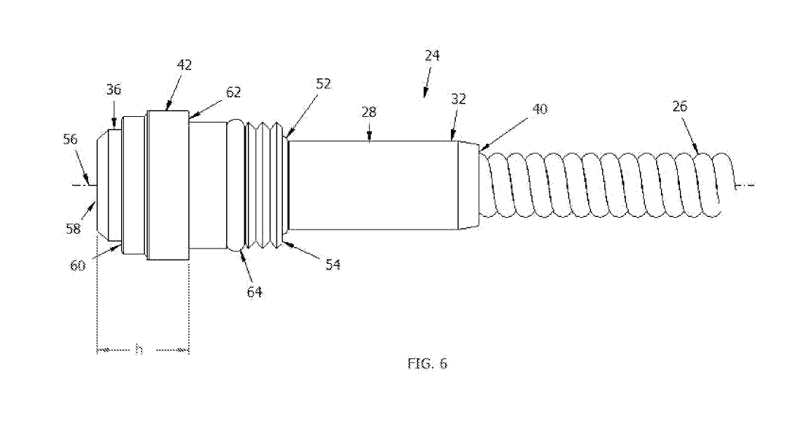

Turning to FIGS. 6-9, the head 36 is linearly retractable from the resting position into the sleeve 42 by application of an axial force F upon an outer face 58 of the head. In the compressed position, the head 36 may be fully retracted into the sleeve 42 and the face 58 of the head is aligned with an outer edge 60 of the sleeve adjacent the opening 44. The head 36 alternatively may be partially retracted into the sleeve 42. The biasing member(s) return the head 36 to the resting position when the axial force F is removed. The sliding movement of the head 36 into and out of the sleeve 42 changes the effective “head length” h of the end-fitting. The “head length” h is the distance in the axial direction from the face 58 of the head 36 to an edge 62 on the outer surface of the sleeve. The variability of the “head length” h upon application of a force F allows the end-fitting 28 to adjust its length when it is mated with an wire feeder adapter of a welding gun cable so that the end-fitting is snugly seated in the adapter while not interfering with other components. The self-adjusting head length of the compressible end-fitting 28 thereby allows the end-fitting to properly seat in a wide variety of wire feeder adapters, increasing the versatility of the liner assembly for use with welding systems including a range of wire feeders available in the marketplace.

In order to install the liner assembly 24 in the welding gun 12, an expired liner, if present in the welding gun, must be removed. To remove the old liner, the power cable 20 is disconnected from the wire feeder 22 and the wire feeder adapter (i.e., power pin) is disassembled to release the liner from the wire feeder adapter. The contact tip assembly 18 (including nozzle, tip, retaining head, etc.) at the front of the welding gun 12 is also disassembled. The existing expired liner is then pulled out of the welding gun 12 and power cable 20. A new liner assembly 24 is then installed by locking the compressible end-fitting 28 in the wire feeder adapter and feeding the tubular liner 26 of the liner assembly through the power cable 20 into the front end of the welding gun 12. Once the end-fitting 28 is mated with the wire feeder adapter, the head length h self-adjusts so that the face 58 of the head 36 snugly contacts a seating surface of the wire feeder adapter. The biasing members 50 push the head 36 outwardly toward the seating surface of the wire feeder adapter, and the force F of the seating surface against the face 58 of the head 36 compresses the head into the sleeve 42 so that there is no gap between the end-fitting and the seating surface while assuring that the end-fitting is not too long for the wire feeder adapter. The end of the tubular liner 26 extending from the front end of the welding gun 12 is trimmed, and the components of the contact tip assembly 18 are reassembled on the welding gun. The wire feeder adapter at the end of the power cable 20 is then reconnected to the wire feeder 22.

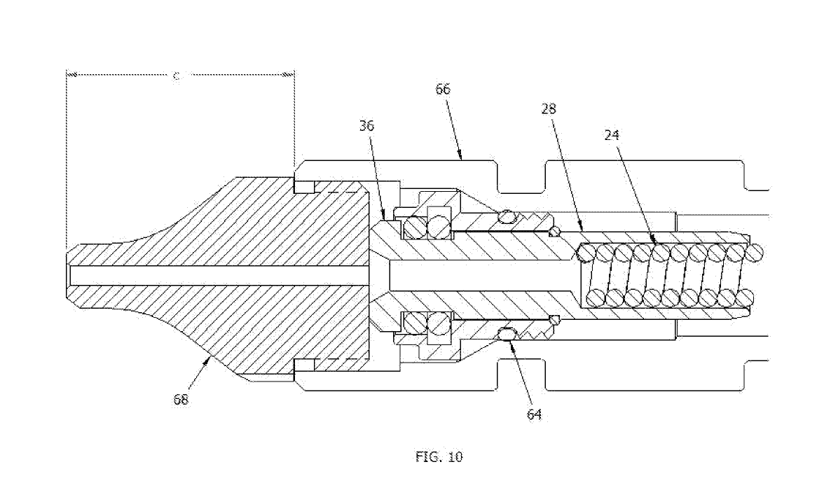

For example, as shown in FIG. 10, the liner assembly 24 is installed into a typical wire feeder adapter 66 and a threaded adapter tip 68 mates with threads in the wire feeder adapter to enclose the liner assembly in the wire feeder adapter. The adapter tip 68 is screwed into the wire feeder adapter 66 until it is positively stopped by a shoulder on the adapter tip. The adapter tip 68 extends a critical distance c from the end of the wire feeder adapter 66, the critical distance being a distance that allows the wire feeder adapter 66 and tip 68 to properly mate with a wire feeder. The adapter tip 68, while just contacting the head 36 of the compressible end-fitting 28 of the liner assembly 24, does not apply any compression force to the end-fitting, and therefore the end-fitting remains in the uncompressed resting position. Also, welding gas within the bore of the wire feeder adapter 66 is contained by the O-ring seal 64.

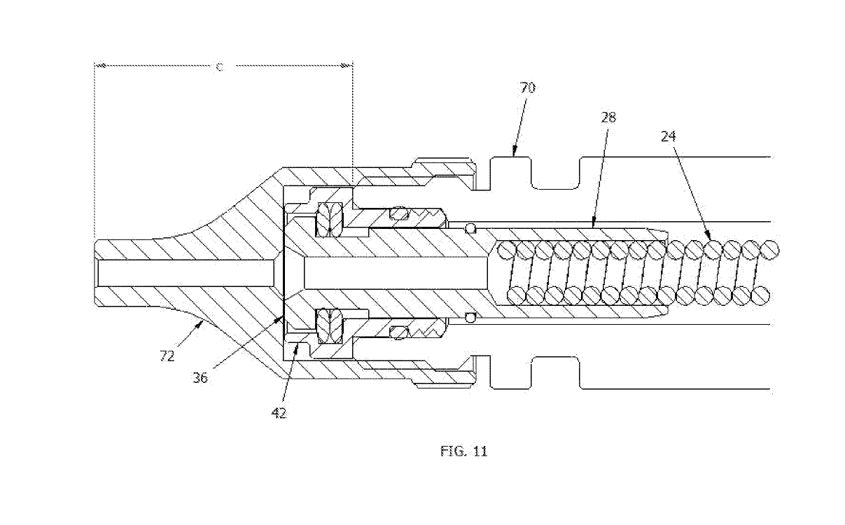

Turning to FIG. 11, the liner assembly 24 is shown installed into another typical wire feeder adapter 70. The liner assembly 24 is seated in the wire feeder adapter 70, and a threaded adapter tip 72 is mated with corresponding threads on the wire feeder adapter. When the adapter tip 72 is screwed onto the wire feeder adapter 70, the adapter tip contacts the compressible end-fitting 28 and applies a force to the head 36 of the end-fitting. The head 36 of the end-fitting 28 is fully compressed such that the adapter tip 72 contacts the stationary portion (sleeve 42) of the end-fitting. The sleeve 42 acts as a positive stop and allows the critical distance c of the adapter tip 72 to be maintained. Thus, if the end-fitting 28 did not have a compressible head, the adapter tip 72 would extend beyond the critical distance and would contact and interfere with the drive rolls of the wire feeder when the power cable is connected to the wire feeder.

Thus, the liner assembly 24 is compatible with multiple styles of wire feeder adapters, and can be universally used without regard to the style of the wire feeder adapter. Further, although not shown in the drawings, the liner assembly 24 also may be used with wire feeder adapters that do not require an adapter tip. While this type of wire feeder adapter negates the use of the compressible head 36, the liner assembly 24 is designed to properly mate with a tipless style of wire feeder adapter.

Although the assembly has been described by reference to a specific embodiment, it should be understood that numerous changes may be made within the spirit and scope of the inventive concepts described. Accordingly, it is intended that the assembly not be limited to the described embodiment, but that it have the full scope defined by the language of the following claims.

What is claimed is:

1. A compressible end-fitting for a welding gun liner, the compressible end-fitting comprising:
a tubular body including a head;
a sleeve;
a portion of the tubular body being received in the sleeve, and the head extending from an end of the sleeve;
wherein the disposition of the head relative to the sleeve is self-adjustable upon application of an axial force against the head in order to vary the length of the end-fitting.

2. The compressible end-fitting of claim 1, including at least one biasing member engaged with and disposed between the head and the sleeve.

3. The compressible end-fitting of claim 1, wherein each biasing member is an O-ring.

4. A compressible end-fitting for a welding gun liner, the compressible end-fitting comprising:
a tubular body;
a head disposed at an end of the tubular body, the head being wider in diameter than the tubular body;
a sleeve disposed around the end portion of the tubular body that includes the head, the sleeve including a stepped inner surface defining a shoulder;
at least one biasing member disposed between the head and the shoulder, the at least one biasing member urging the head outwardly away from the sleeve;
an annular stop on an outer surface of the tubular body, the annular stop being contactable with an edge of the sleeve to limit movement of the head relative to the sleeve;
wherein the head is linearly retractable from a resting position into the sleeve by application of an axial force, and the at least one biasing member returns the head to the resting position when the axial force is removed.

5. The compressible end-fitting of claim 4, wherein each biasing member is an elastically compressible member.

6. The compressible end-fitting of claim 5, wherein the elastically compressible member is an O-ring.

7. The compressible end-fitting of claim 4, wherein each biasing member is a spring.

8. The compressible end-fitting of claim 4, including a seal disposed around an outer surface of the sleeve.

9. The compressible end-fitting of claim 8, wherein the seal is an O-ring.

10. A liner assembly for a welding gun, the liner assembly comprising:
a tubular liner; and
a compressible end-fitting connected to an end of the tubular liner;
the compressible end-fitting including:
a tubular body;
a head disposed at an end of the tubular body, the head being wider in diameter than the tubular body;
a sleeve disposed around the end portion of the tubular body that includes the head, the sleeve including a stepped inner surface defining a shoulder;
at least one biasing member disposed between the head and the shoulder, the at least one biasing member urging the head outwardly away from the sleeve;
an annular stop on an outer surface of the tubular body, the annular stop being contactable with an edge of the sleeve to limit movement of the head relative to the sleeve;
wherein the head is linearly retractable from a resting position into the sleeve by application of an axial force, and the at least one biasing member returns the head to the resting position when the axial force is removed.

11. The liner assembly of claim 10, wherein the tubular liner and the compressible end-fitting have a common axis.

12. The liner assembly of claim 11, wherein the tubular liner and the compressible end-fitting are rotatable with respect to each other about the common axis.

13. The liner assembly of claim 11, wherein the tubular liner and the compressible end-fitting are moveable linearly with respect to each other along the common axis.

14. A welding system comprising:
a welding gun;
a wire feeder;
a power cable connecting the welding gun to the wire feeder; and
a liner assembly including a tubular liner and a compressible end-fitting connected to an end of the tubular liner, the liner assembly extending through the power cable from the wire feeder to the welding gun;
the compressible end-fitting including:
a tubular body;
a head disposed at an end of the tubular body, the head being wider in diameter than the tubular body;
a sleeve disposed around the end portion of the tubular body that includes the head, the sleeve including a stepped inner surface defining a shoulder;
at least one biasing member disposed between the head and the shoulder, the at least one biasing member urging the head outwardly away from the sleeve;
an annular stop on an outer surface of the tubular body, the annular stop being contactable with an edge of the sleeve to limit movement of the head relative to the sleeve;
wherein the head is linearly retractable from a resting position into the sleeve by application of an axial force, and the at least one biasing member returns the head to the resting position when the axial force is removed.

15. The welding system of claim 14, wherein the power cable includes a wire feeder adapter affixed on an end thereof, the wire feeder adapter being coupled with the wire feeder, and the liner assembly being received in the wire feeder adapter.

16. The welding system of claim 14, wherein the wire feeder adapter includes an adapter tip, the adapter tip contacting the head of the liner assembly and applying said axial force on the head.
